(19) United States
(12) Patent Application Publication
(10) Pub. No.: US 2023/0220267 A1
(43) Pub. Date: Jul. 13, 2023

(54) Nano-Modified Polymer Injectate for Improving Energy Sweep in Geothermal Reservoirs and Methods of Making

(71) Applicant: UNM Rainforest Innovations, Albuquerque, NM (US)

(72) Inventors: John C. Stormont, Albuquerque, NM (US); Mahmoud Reda Taha, Albuquerque, NM (US); Usama Farid Kandil, Cairo (EG)

(73) Assignee: UNM Rainforest Innovations, Albuquerque, NM (US)

(21) Appl. No.: 18/152,714

(22) Filed: Jan. 10, 2023

Related U.S. Application Data
(60) Provisional application No. 63/297,990, filed on Jan. 10, 2022.

(51) Int. Cl. C09K 8/508; C09K 8/516; E21B 43/27

(52) U.S. Cl. CPC C09K 8/5086; C09K 8/516; E21B 43/27; C09K 2208/10; C09K 2208/26

(57) ABSTRACT

The present invention provides a device, system, and method that eliminates the short-circuiting and improves energy sweep in geothermal reservoirs.

### RELATED APPLICATIONS

This application claims priority to U.S. Provisional Application No. 63/297,990, filed on Jan. 10, 2022, which is incorporated herein in its entirety.

### STATEMENT REGARDING FEDERALLY SPONSORED RESEARCH & DEVELOPMENT

Not applicable.

### INCORPORATION BY REFERENCE OF MATERIAL SUBMITTED ON A COMPACT DISC

Not applicable.

### BACKGROUND OF THE INVENTION

In geothermal wells, energy is extracted by circulating water through a network of connected fractures. Short-circuiting, a term used to express a noticeable reduction in energy extraction efficiency in a geothermal reservoir, is a significant challenge in geothermal wells that typically occur due to the increase in fracture opening size. Such an increase results in these fractures conducting more flow through them than intended, which reduces the amount of thermal energy extracted from the rock formation. Highly conductive fractures negatively impact the reservoir sweep efficiency. There is a significant need for a method to stop/or reduce the short-circuiting and improve energy sweep in geothermal reservoirs.

### BRIEF SUMMARY OF THE INVENTION

In one embodiment, the present invention provides a device, system, and method that eliminates the short-circuiting and improve energy sweep in geothermal reservoirs.

In another embodiment, the present invention provides a device, system, and method that can selectively modify fractures in the fracture network in geothermal reservoirs to improve energy sweep.

In another embodiment, the present invention provides a device, system, and method that controls the permeability of fracture networks in geothermal reservoirs and thus eliminates short-circuiting.

In another embodiment, the present invention provides a device, system, and method that bonds an active porous multi-layered polymer network inside subsurface fractures to reduce permeability and improve energy sweep.

In another embodiment, the present invention provides a device, system, and method that control the polymerization process to produce porous polymer network and enable forming it in multi-layers adhered together and to the rock formation.

In another embodiment, the present invention provides a device, system, and method that deliver polymer injectate to the fracture surface to improve the energy sweep efficiency.

In another embodiment, the present invention provides a device, system, and method that provide a nano-modified polymer/monomer with very high wettability to penetrate fracture surfaces in the rock formation, push water out of those spaces, bond to fracture surfaces in the rock formation, and polymerize to form a porous polymer network with controlled porosity and permeability.

In another embodiment, the present invention provides a device, system, and method that provide a flexible multi-layer porous polymer with enhanced mechanical properties, high fatigue strength, superior bond between layers, and excellent bond with fracture surfaces in rock formations.

In another embodiment, the present invention provides a device, system, and method that provide high-pressure spherical microcapsules incorporating expansive materials triggered by the temperature inside the fracture to expand and reduce the permeability inside the fracture.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1 shows an embodiment of the present invention showing how nano-modified polymer injectate allows sequentially building multi layers of the porous polymer adhered to each other and fracture surfaces.

FIG. 2 illustrates an embodiment of the present invention showing how porous polymers can be developed in large fracture networks in the subsurface rock formations by injecting an engineered mix of a polymerizable monomer with a low molar mass preferred organic solvent, which is initially miscible with the monomer and separates upon polymerization.

FIG. 3 illustrates another embodiment of the present invention showing how a -fluorinated-nano modified polymer resin which may be used as a base material to coat the open fracture surface, penetrate the rock formation, and form a porous polymer network which is firmly adhered to the fracture surface.

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure, or system. Further, the terms and phrases used herein are not intended to be limiting, but rather to provide an understandable description of the invention. In one embodiment, the present invention provides a method, device, and system to eliminate short-circuiting, reduce the effective permeability of the fracture network, and improve the energy sweep in geothermal reservoirs. The embodiments of the present invention reduce flow in larger fractures.

In a preferred embodiment, the present invention concerns a nano-modified polymer injectate having a specific viscosity and incorporates microparticles to prevent its ingress into a small fracture network. The nano-modified polymer injectate is used to fill the fracture opening and thus limit water flow to eliminate short-circuiting in geothermal reservoirs and improve energy sweep efficiency. The nano-modified polymer injectate creates a multi-layer porous polymer network inside the large fractures leading to reduced permeability and improved energy sweep.

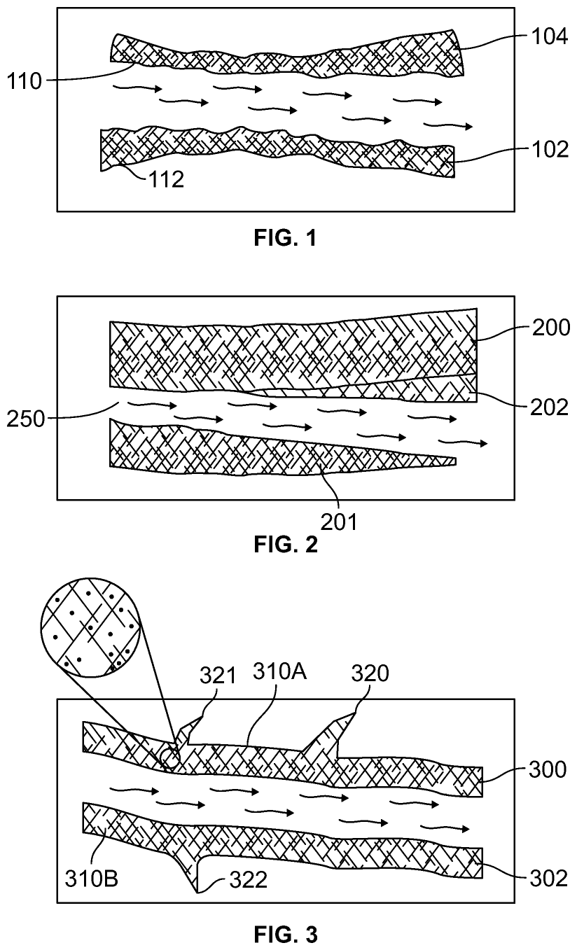

As shown in FIG. 1, in one embodiment, the nano-modified polymer injectate allows sequentially building multi layers of the porous polymer 102 and 104 adhered to each other and fracture surfaces 110 and 112. Adjusting the mobility ratio of the nano-modified polymer injectate to water (or the geothermal energy reservoir water-formation liquid) controls the ability to flow the new nano-modified polymer injectate inside cracks in fractures surfaces 110 and 112 of rock formations. The nano-modified polymer injectate is designed to push the water out of the fracture opening and occupy that space and harden to form a porous polymer network adhering to the fracture surface.

In other embodiments, as shown in FIG. 2, porous polymers can be developed in large fracture networks in the subsurface rock formations by injecting an engineered mix of a polymerizable monomer with a low molar mass preferred organic solvent, which is initially miscible with the monomer and separates upon polymerization. Polymerization of the above mix at high temperatures will result in the formation of a porous polymer network due to the evaporation of the solvent. This allows a user to partially fill the fracture and thus not completely block flow in the fracture. The amount of flow blockage in the fracture can be adjusted by increasing or decreasing the amount of solvent which controls the porosity of the porous polymer. Latent hardeners may also be used to control polymerization at the desired temperature in the rock fracture after injection.

As also shown in FIG. 2, the polymer layers may be added sequentially such as by first forming layers 200 and 201 and then later adding layer 202. Fluid flow inside fracture 250 may be controlled and optimized by varying the thickness of layers 200-202 as well as the location and the number of layers used and the resulting porosity of these layers

In other embodiments, the present invention formulates a highly thermally stable polymer network using a micro-capsulated anionic catalyst (a Lewis base such as tertiary amines or imidazoles) or a cationic catalyst (a Lewis acid such as a boron trifluoride complex) to enable catalytic homopolymerization where the polymer will react with itself and polymerize under temperature stimulation. The materials and method allow the chemical bonding of the different porous polymer layers via reactive chemical groups through several injections of the nano-modified polymer injectate.

Enabling a multi-layer bond-active porous polymer network can be achieved by controlling the polymerization process by engineering the amount of hardener, using latent hardeners, and creating a mix of polymerized and non-polymerized polymer mix. The materials and methods of the present invention, ensure that the multi-layer porous polymer network, injected at different times, adheres together and to the fracture surface in the rock formation, thus filling all or a portion of the fracture opening to a sufficient extent necessary to reduce permeability, eliminate or reduce short-circuiting and improve energy sweep.

The degree of porosity, connectivity, and permeability of the multi-layer porous polymer network of the present invention is designed to meet the desired water permeability of the fracture. In the event, that multi-layer porous polymer does not seal the fracture to the desired degree, an additional injection of the polymer injectate can be applied to reduce polymer porosity. Controlling the starting mixing ratio of the engineered polymer mixture creates a multi-layer porous polymer that is removable and or one that can be dissolved to reverse the process.

In another embodiment, as shown in FIG. 3, the present invention provides a silaneated-fluorinated-nano modified polymer resin which may be used as base material 300 and 302 to coat open fracture surface 310A and 310B, penetrate the rock formation including rock cracks 320-322, and form a porous polymer network which is firmly adhered to the fracture surface. Potential polymers that may be used as the base material for the porous polymer include but are not limited to Epoxy resins (Novolac Epoxy, Amine Epoxy, etc.), Esters, Altium, PEEK, and other high-temperature polymers. Fluorinated polymers are suggested for their low surface tension acting as a wetting agent to penetrate and bond to fracture surface in the rock formation. Silaneated polymers are suggested to allow developing high bond strength to most of the rock formation surfaces. Alumina nanoparticles (as an additive with amphoteric nature) may also be used to control the polymerization process and improve the bond of the porous polymer network to the rock formation. Alumina nanoparticles also will improve polymer flexibility and fatigue resistance for thermal stress cycles. Other nanoparticles incorporating carbon nanotubes, carbon nanofibers, ferrite nanoparticles, etc. may also be used to improve the physical and mechanical characteristics of the multi-layer porous polymer network.

The thermal conductivity of the porous polymer network is controlled by selecting the nano-filler, “e.g., nano-silica” to achieve a desired thermal conductivity.

The nano-modified polymer injectate of the present invention should be well-suited to work in a plethora of rock formations typically containing geothermal energy reservoirs (e.g., granite, limestone, sandstone, feldspar, etc.).

In other aspects, the present invention concerns the inclusion of nano and micro particulates with specific size and surface functionalization to alter the polymer viscosity and mobility ratio to prevent the polymer from entering fractures below a particular size.

In other aspects, the present invention concerns nanoparticles (e.g., functionalized nano-silica) used to improve the bond between the multi-layer porous polymer network and the fracture surfaces in the rock formation.

In other aspects, the present invention concerns the injection of surface activated microparticles bond to the porous polymer network enabling an alternative method to reduce the multi-layer porous polymer network porosity and the partially filled crack permeability.

In other aspects, the present invention concerns industrial grade, nitrogen treated, and/or nano-modified polymer injectate incorporating carbon nanotubes, carbon nanofibers, alumina nanoparticles, zinc nanoparticles, and silica nanoparticles and other nanoparticles.

In other aspects, the present invention concerns a delivery method that depends on the size of the fracture to be modified and the presence of adjacent fractures. The polymerization process is engineered to consider viscosity, mixing ratio, and mobility ratio to control fracture size in large and small fractures.

In other aspects, the present invention, for large fractures, concerns reactants that can be delivered in microcapsules that are small enough to enter the targeted fracture but not so small as to enter and plug adjacent, small fractures. The use of microcapsule technology allows the conditions of injectate reactivity to be controlled by designing the microcapsules to rupture at the desired temperature and stress conditions.

In other aspects, the present invention concerns high-pressure microcapsules which are included in the polymer injectate. The microcapsules are designed using high strength and ductile polymer membrane not to rupture under high pore pressure. The microcapsule surface is functionalized to bond to the porous polymers and/or the rock formation. The microcapsules incorporate reactive expansive constituents. The expansive reaction is triggered by the high temperature inside the targeted fracture. The expansion is significant enough to lock the microcapsules inside the fracture. The enlarged microcapsules will allow water flow through the pores between them but will reduce the permeability inside the fracture.

In yet another embodiment, the present invention provides a method to modify the permeability of fractures in a fracture network in geothermal reservoirs to improve energy sweep. The method includes the steps of introducing an injectate into the fracture network. The injectate may be comprised of compositions disclosed above such as a resin base, hardener, and nanoparticles. Once the resin and hardener react, the resulting polymer displaces water and bonds to fractures within the network.

To render the resulting polymer porous, prior to polymerization, a solvent may be added. The evaporation of the solvent creates a porous polymer. The porosity of the resulting polymer may be modified by the amount and type of solvent.

To avoid filling or modifying desired cracks within a fracture network, such as those within a desired size range, the microcapsules may be sized to target specific crack sizes outside of the desired range. For example, to only affect cracks of a predetermined minimum size or larger, the microcapsules are sized to only enter and move within a set predetermined crack size.

In other applications the microcapsules contain various cargo. Cargo may include such components as solvent, nanoparticles, hardener and other materials that may be used by the process.

To steer or direct the injectate to certain locations within a fracture network, the injection pressure used may be varied. Another technique is to vary the flow rate of the injectate. Alternately, both the injection pressure and flow rate may be varied as desired.

The disclosure should therefore not be limited by the above described embodiments, methods, and examples, but by all embodiments and methods within the scope and spirit of the disclosure.

What is claimed is:

1. A method to modify the permeability of fractures in a fracture network in geothermal reservoirs to improve energy sweep comprising the steps: introducing an injectate into the fracture network; said injectate comprising a resin base, hardener, and nanoparticles; once said resin and hardener react, the resulting polymer displaces water and bonds to the fracturers.

2. The method of claim 1 further including the steps of introducing a solvent to said injectate and evaporating said solvent, said evaporation of said solvent renders said polymer porous.

3. The method of claim 1 wherein said hardener is encapsulated in microcapsules, said microcapsules adapted to degrade as a function of temperature and thereby release said hardener in a controlled manner.

4. The method of claim 3 wherein said microcapsules are sized to enter and move within a predetermined crack size.

5. The method of claim 3 wherein said microcapsules contain solvent and nanoparticles.

6. The method of claim 3 wherein said microcapsules contain said solvent.

7. The method of claim 3 wherein said microcapsules contain said nanoparticles.

8. The method of claim 1 wherein a plurality of said injectate is introduced.

9. The method of claim 1 wherein said injectate is directed to a predetermined location by varying the injection pressure and flow rate.

10. The method of claim 1 wherein said injectate is removed with an acid.

11. The method of claim 1 wherein said porosity of the resulting polymer is modified by the amount and type of solvent.

12. The method of claim one wherein said resin is a silaneated-fluorinated nano modified polymer resin.
